(19) United States
(12) Patent Application Publication
(10) Pub. No.: US 2019/0183722 A1
(43) Pub. Date: Jun. 20, 2019

(54) Massage Chair Having a Noise-Reducing Enclosure Device, Hammering Devices, and Oxygen Generation

(71) Applicant: Luraco Technologies, Inc., Arlington, TX (US)

(72) Inventors: Kevin Le, Richland Hills, TX (US); Thanh Le, Grand Prairie, TX (US); Varad Nitin Gokhale, Irving, TX (US)

(21) Appl. No.: 16/283,186

(22) Filed: Feb. 22, 2019

Related U.S. Application Data
(63) Continuation-in-part of application No. 15/593,320, filed on May 11, 2017.

(51) Int. Cl. A61H 9/00; H02J 50/12; A47C 1/00

(52) U.S. Cl. CPC A61H 9/0071; H02J 50/12; A61H 2201/5048; A47C 1/00; A61H 2201/0149; A61H 9/0078

(57) ABSTRACT

The disclosure is directed to a massage chair having a massage chair frame, a massage system, and a noise-reducing, enclosure device. The massage chair frame includes a first end, a second end, a seat body area portion, and a back body area portion. The massage system includes at least one air massage element, an air pump, and at least one air valve device for regulating air flow into and out of the at least one air massage element. The noise-reducing, enclosure device includes an enclosure housing and noise-reducing material positioned inside the enclosure housing. The enclosure housing encloses the air pump and the plurality of air valve devices during operation during operation such that noise generated from or made by the air pump and the plurality of air valve devices during operation is reduced, contained or eliminated. Additionally, the disclosure provides additional features for improving user experience including hammering devices, heating acupuncture devices, oxygen generation, voice recognition control, a remote control pouch, and a wireless device pouch having wireless charging functionality.

### CROSS REFERENCE TO PRIOR APPLICATIONS

This application is a continuation in part of U.S. patent application Ser. No. 15/593,320, filed May 11, 2017, which is incorporated herein by reference in its entirety.

### BACKGROUND OF THE DISCLOSURE

### Field of the Invention

The disclosure generally relates to massage chairs, massage devices and apparatuses for massage chairs, and noise-reducing devices and systems. More specifically, the disclosure is directed to a massage chair having a noise-reducing, enclosure device. Additionally, the disclosure is directed to a massage chair having hammering devices. Moreover, the disclosure is directed to a massage chair having heated acupuncture devices. Additionally, the disclosure is directed to an oxygen generator for generating oxygen for user. Moreover, the disclosure is directed to a massage chair having a remote control pouch and a wireless device pouch having wireless charging functionality. Additionally, the disclosure is directed to voice recognition control of the massage chair.

### Description of the Related Art

Massage chairs, massage devices and apparatuses for massage chairs, and noise-reducing devices and systems are known in the art.

In many current massage systems and devices related to massage chairs, the massage system or device usually has an air compressor to pump air into the air cells or bags throughout the massage chair to provide massage effects to users of the massage chair at air massage pressure points. Due to the electro-mechanical movement to generate the compressed air, the air compressor can make a very unpleasant noise when it operates. In addition, the air valves' operation to control the air flow into and out of air cells are also noisy. Thus, a massage chair having a noise-reducing, device or system is desired for reducing noise generated from and/or made by these devices so as to make the massage environment more quiet and relaxing for users of the massage chair.

The disclosure overcomes one or more of the shortcomings of massage chairs, massage devices and apparatuses for massage chairs, and noise-reducing devices and systems. The Applicant is unaware of inventions or patents, taken either singly or in combination, which are seen to describe the disclosure as claimed. Additionally, the disclosure provides additional features for improving user experience including hammering devices, heating acupuncture devices, oxygen generation, voice recognition control of the massage chair, a remote control pouch, and a wireless device pouch having wireless charging functionality.

### SUMMARY OF THE DISCLOSURE

The disclosure is directed to a massage chair having a massage chair frame, a massage system that includes a plurality of air massage elements, and a noise-reducing (or noise-absorbing, noise-containing or noise-cancelling) enclosure device. Additionally, the disclosure is directed to additional features for improving user experience including hammering devices, heating acupuncture devices, oxygen generation, voice recognition control of the massage chair, a remote control pouch, and a wireless device pouch having wireless charging functionality.

The massage chair frame includes a first end, a second end, a seat or bottom body area portion, and a back body area portion extending upward from the seat or bottom body area portion toward the second end. Preferably, the massage chair frame also includes a thigh body area portion located between the seat or bottom body area portion and the first end, a head and neck body area portion extending upward from the back body area portion and located about the second end, and a lower leg body area portion located downward (or extending downward) from the thigh body area portion and located about the first end.

The massage system includes at least one air massage element, an air compressor or pump, and at least one air valve device for regulating air flow into and out of the at least one air massage element. Preferably, the massage system also comprises at least one air transport device and a power source. Also preferably, the at least one air massage element is a plurality of air massage elements, the at least one air valve device is a plurality of air valve devices, and the at least one air transport device is a plurality of air transport devices. The massage system is in operational communication with the massage chair frame such that the massage system provides massaging effects to a user positioned in the massage chair.

Each of the plurality of air massage elements is adapted for having air transported or pumped into it by the air compressor or pump and for having air withdrawn from it. The plurality of air massage elements may be positioned at predetermined massage locations on, about, or in the vicinity of the massage chair frame and/or may be moved or transported to desired massage locations by the user.

The air compressor or pump pumps air into the plurality of air massage elements such that massaging effects can be provided to the user at desired massage locations or pressure points.

The plurality of air valve devices regulate air flow into and out of the plurality of air massage elements.

The plurality of air transport devices transport air flow into and out of the plurality of air massage elements.

The power source provides power to the air compressor or pump, and may also be used to provide power to other components of the massage chair.

The noise-reducing (or noise-absorbing, noise-containing, or noise-cancelling) enclosure device includes an enclosure housing. The enclosure housing may comprise a layer of noise-reducing (or noise-absorbing, noise-containing, or noise-cancelling) material positioned inside. The enclosure housing encloses the air compressor or pump and the plurality of air valve devices during operation. The noise-reducing, enclosure device is preferably positioned in proximity of the massage chair frame.

The enclosure housing encloses the air compressor or pump and the plurality of air valve devices during operation such that noise generated from or made by the air compressor or pump and the plurality of air valve devices during operation is reduced, contained or eliminated.

Preferably, the noise-reducing (or noise-absorbing, noise-containing, or noise-cancelling) material is positioned inside the enclosure housing in such a way that it surrounds the air compressor or pump and the plurality of air valve devices such that noise generated from or made by the air compressor or pump and the plurality of air valve devices during operation is reduced, contained or eliminated.

### BRIEF DESCRIPTION OF THE DRAWINGS

FIG. 1 is a right side, perspective view of a massage chair according to the disclosure.

FIG. 2 is a perspective view of a massage chair frame for a massage chair according to the disclosure.

FIG. 3 is a front view of the massage chair frame of FIG. 2.

FIG. 4 is a right side view of the massage chair frame of FIG. 2.

FIG. 5 is a rear, partial perspective view of a massage chair frame and a massage system of a massage chair according to the disclosure.

FIG. 6 is a top, partial perspective view of a massage system and a noise-reducing, enclosure device of a massage chair according to the disclosure.

FIG. 7 is a top, perspective view of the noise-reducing, enclosure device of FIG. 6.

FIG. 8 is a bottom, perspective view of the noise-reducing, enclosure device of FIG. 6.

FIG. 9 is a perspective view of a securing nut of the noise-reducing, enclosure device of FIG. 6.

FIG. 10 is a top, perspective view of the massage system and the noise-reducing, enclosure device of FIG. 6, with a top of the noise-reducing, enclosure device being temporarily removed.

FIG. 11 is a partial cut-away, top, perspective view of the massage system and the noise-reducing, enclosure device of FIG. 6, with a top of the noise-reducing, enclosure device being temporarily removed.

FIG. 12 is a perspective view of noise-reducing material of the noise-reducing, enclosure device of FIG. 6.

FIG. 13A is a side, perspective view of an air massage element and an air transport device of a massage system of a massage chair according to the disclosure.

FIG. 13B is a perspective view of the air massage element and the air transport device of FIG. 13A.

FIG. 13C is an opposite side, perspective view of an air massage element and an air transport device of a massage system of a massage chair according to the disclosure.

FIG. 14 is an elevated, front view of a massage chair, showing multiple locations where air massage elements may be positioned.

FIG. 15 is an elevated, front view of a massage chair, showing multiple locations where hammer punching devices may be positioned.

FIG. 16 illustrates a cross-sectional view of a hammer punching device according to the disclosure.

FIG. 17 illustrates a perspective view of a hammer punching device according to the disclosure.

FIG. 18 is an exploded view of the chair with armrest removed according to the disclosure.

FIG. 19 illustrates an armrest sliding feature according to another aspect of the disclosure.

FIG. 20 is a perspective view of a sliding wing, another mounting option for armrest sliding feature according to another aspect of the disclosure.

FIG. 21 illustrates a perspective view of an enclosure section for air valves according to the disclosure.

FIG. 22 illustrates a perspective view of the enclosure section for air valves according to FIG. 21 with a top cover removed.

FIG. 23 illustrates a perspective view of the enclosure section for air valves according to FIG. 21 with a top cover in front cover removed.

FIG. 24 illustrates a side view of the massage chair frame with an oxygen generator according to the disclosure.

FIG. 25 illustrates an oxygen generator according to the disclosure.

FIG. 26 illustrates a massage chair having an oxygen distribution system according to the disclosure.

FIG. 27 illustrates a massage chair having a wireless device pouch and a remote control pouch according to the disclosure.

FIG. 28 illustrates a wireless charger configured to be implemented in the massage chair according to the disclosure.

It should be understood that the above-attached figures are not intended to limit the scope of the disclosure in any way.

### DETAILED DESCRIPTION OF THE PREFERRED EMBODIMENTS

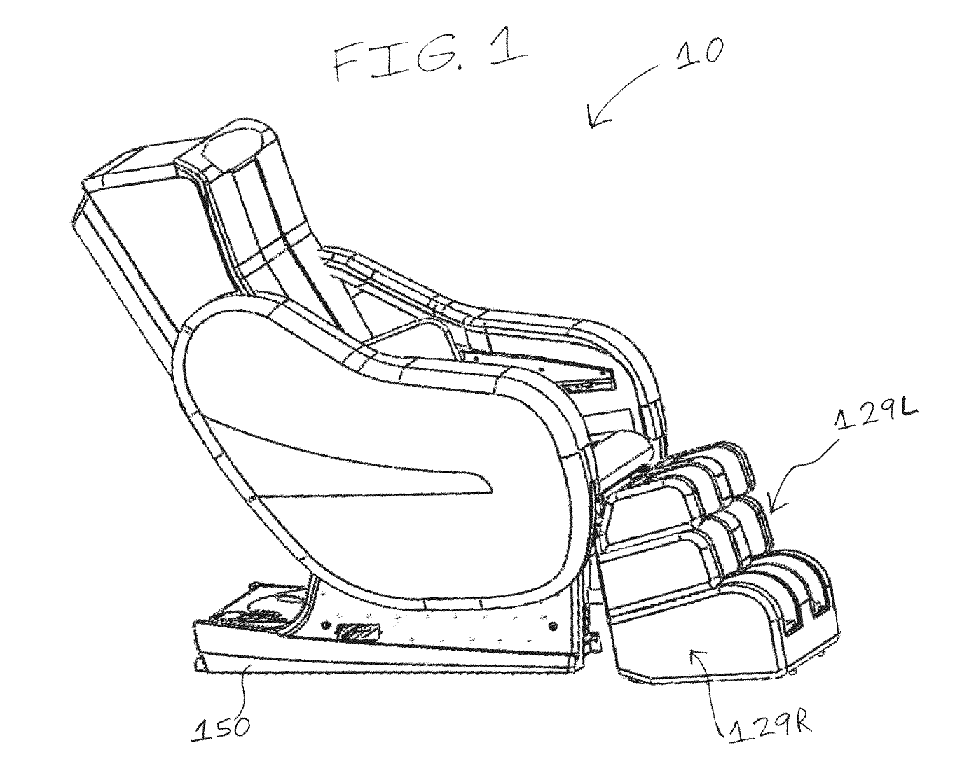

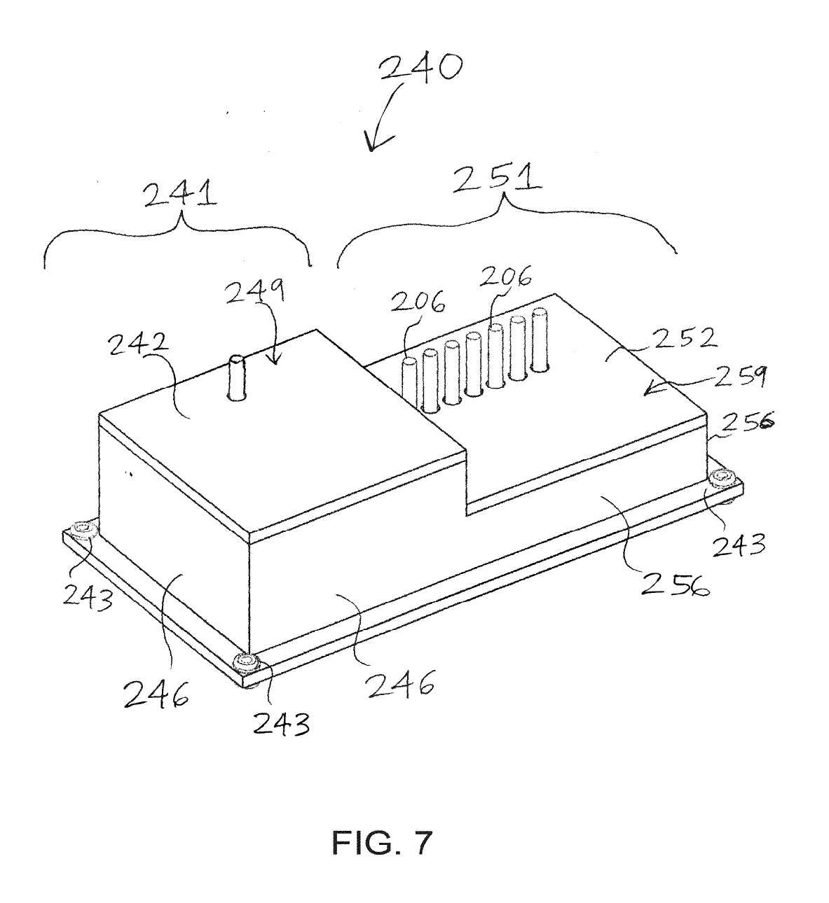

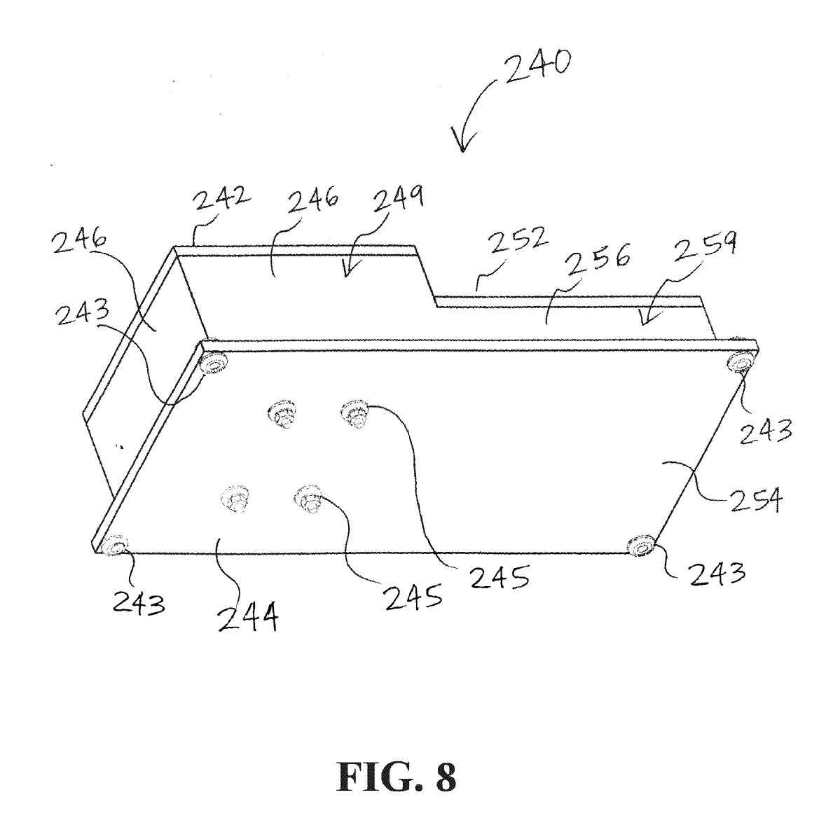

Referring to FIGS. 1-14, the disclosure is directed to a massage chair 10 having a massage chair frame 110, a massage system 170 that includes a plurality of air massage elements 180, and a noise-reducing (or noise-absorbing, noise-containing or noise-cancelling) enclosure device 230.

The massage chair frame 110 may include a first end, a second end, a seat or bottom body area portion, and a back body area portion extending upward from the seat or bottom body area portion toward the second end. Preferably, the massage chair frame 110 also includes a thigh body area portion located between the seat or bottom body area portion and the first end, a head and neck body area portion extending upward from the back body area portion and located about the second end, and a lower leg body area portion located downward (or extending downward) from the thigh body area portion and located about the first end. In general, the massage chair frame 110 may be any massage chair frame known to one of ordinary skill in the art that comprises at least a seat or bottom body area portion and a back body area portion.

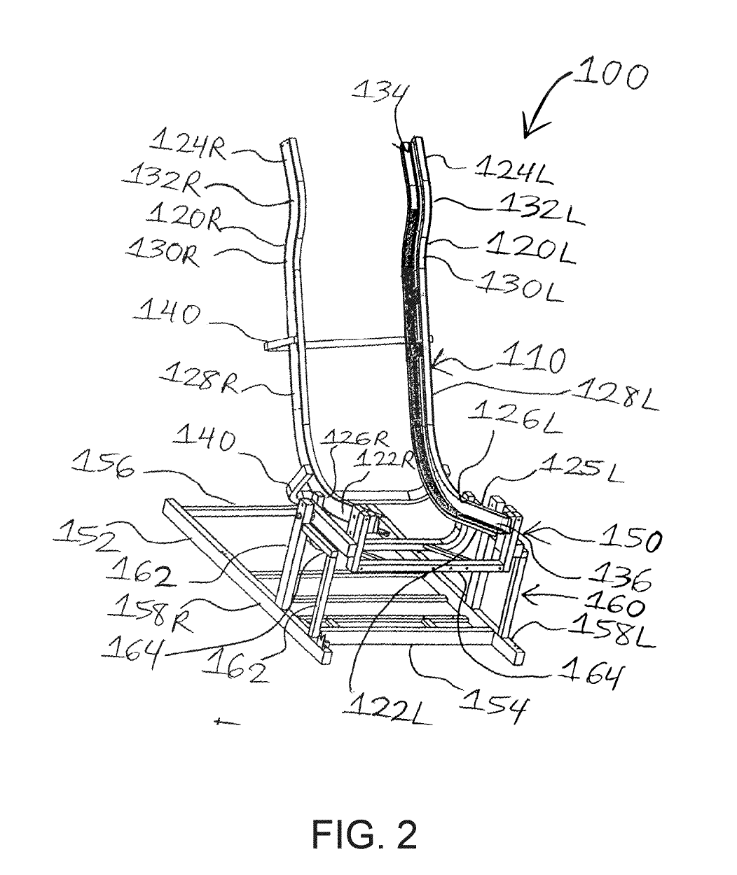

As a non-limiting example and as best shown in FIGS. 2-4, the massage chair frame 110 includes a pair of opposing guide rails 120R,120L, a plurality of guide rails stabilizing bars 140, and a base stand 150. The guide rails 120R,120L are secured to the base stand 150, and are positioned generally above the base stand 150. The base stand 150 supports the weight of the guide rails 120R,120L and, preferably, also the weight of a user (not shown) of the massage chair.

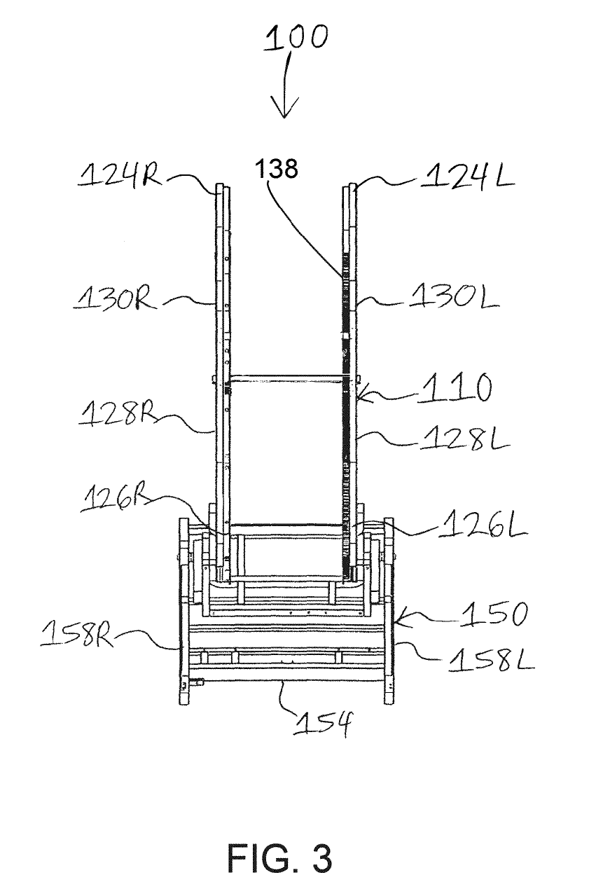

Preferably, the guide rails 120R,120L are substantially similar or mirror images of one another. Each of the guide rails 120R,120L includes a first end 122R,122L, a second end 124R,124L, a thigh body area portion 125R,125L located adjacent the first end 122R,122L, a seat or bottom body area portion 126R,126L located adjacent the thigh body area portion 125R,125L and away from the first end 122R,122L, a back body area portion 128R,128L extending upward from the bottom body area portion 126R,126L, a head and neck body area portion 130R,130L extending upward from the back body area portion 128R,128L and located about the second end 124R,124L, an outer side 132R,132L, an inner side 134, and a guide channel 136 extending from the thigh body area portion 125R,125L to the back body area portion 128R,128L, preferably to the head and neck body area portion 130R,130L, and running along the inner side 134 of the guide rail 120R,120L. The guide channel 136 may include gear teeth 138 for engaging with at least one gear member from a mechanical massage device (not shown) when the mechanical massage device moves upward and downward in a generally vertical direction from the first end 122R,122L toward the second end 124R,124L of the guide rail 120R,120L and vice versa, respectively. Preferably, each of the guide rails 120R,120L has a generally “L-shaped” configuration. In this configuration, the lower portion of the “L” includes the thigh body area portion 125R,125L and bottom body area portion 126R,126L, and the upper portion of the “L” includes the back body area portion 128R,128L and head and neck body area portion 130R,130L. As best shown in FIGS. 1 and 3, more preferably, each of the guide rails 120R,120L has a reclining “L-shaped” configuration.

Preferably, as shown in FIG. 1, the lower leg body area portion 129R,129L is a further extension of the massage chair frame 110, or is an add-on device that is secured or attached about the first end 122R,122L of the guide rails 120R,120L of the massage chair frame 110. Preferably, the lower leg body area portion 129R,129L is located downward (or extending downward) from the thigh body area portion 125R,125L and located downward (or extending downward) from the first end 122R,122L.

The plurality of guide rails stabilizing bars 140 help to stabilize the positioning of the guide rails 120R,120L relative to one another. Each of the guide rails stabilizing bars 140 has a first end 142, a second end 144, and a body portion 146 extending from the first end 142 to the second end 144. Preferably, each of the guide rails stabilizing bars 140 has a generally “U-shaped” configuration. The guide rails stabilizing bars 140 are secured at predetermined locations along the outer sides 132R,132L of the guide rails 120R,120L.

The base stand 150 includes a base 152 and a guide rails support structure 160. The base 152 includes a first or front end 154, a second or rear end 156, and a pair of opposing sides 158R,158L. The guide rails support structure 160 is secured about the front end 154 of the base 152, and is positioned above the base 152. The guide rails support structure 160 includes a plurality of vertical bars or vertical members 162 and a plurality of horizontal bars or members 164. The plurality of vertical bars 162 extend upward from the pair of opposing sides 158R,158L of the base 152, and, along with the plurality of horizontal bars 164, form a support frame with a “square-shaped” or “rectangular-shaped” box configuration.

Since the base stand 150 supports the weight of the guide rails 120R,120L and user of the massage chair, the base stand 150 is preferably made or manufactured of a strong material, such as, but not limited to, steel, metal, wood, hard plastic, any material or combination of materials known to one of ordinary skill in the art, and any combination thereof. Also, each of the guide rails 120R,120L and plurality of guide rails stabilizing bars 140 may be made or manufactured of steel, metal, wood, plastic, any material or combination of materials known to one of ordinary skill in the art, and any combination thereof.

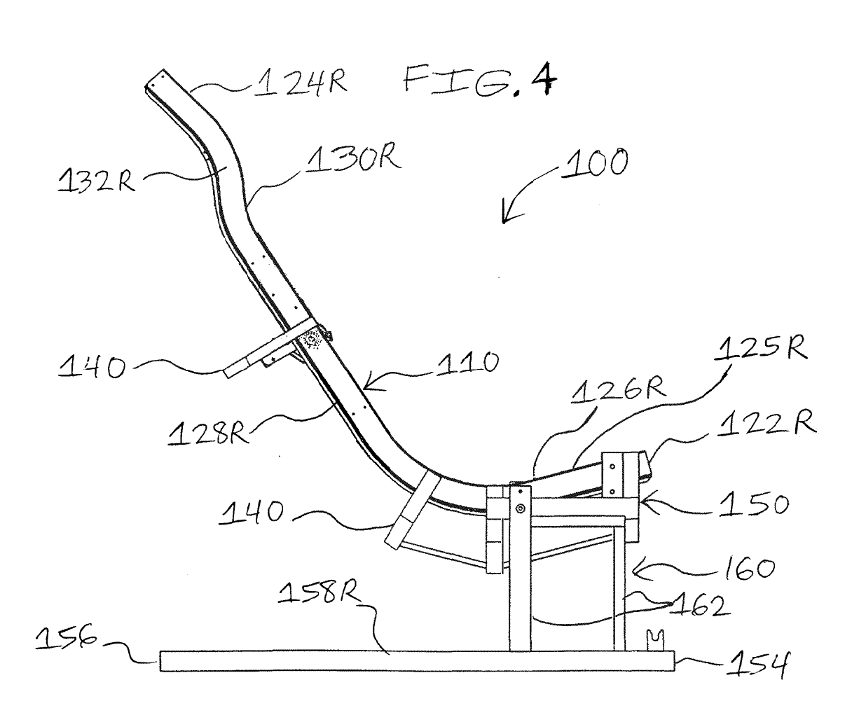

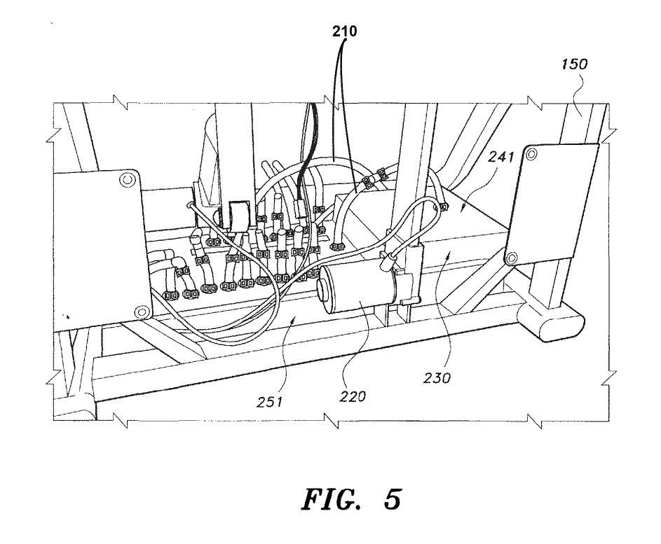

As best shown in FIGS. 5, 6, 14, and 15, the massage system 170 includes at least one air massage element 180, an air compressor or pump 190, and at least one air valve device 200 for regulating air flow into and out of the at least one air massage element 180. Preferably, the massage system 170 also includes at least one air transport device 210 and an actuator 220. Also preferably, the at least one air massage element 180 is a plurality of air massage elements 180, the at least one air valve device 200 is a plurality of air valve devices 200, and the at least one air transport device 210 is a plurality of air transport devices 210. The massage system 170 is in operational communication with the massage chair frame 110 such that the massage system 170 provides massaging effects to a user (not shown) positioned in the massage chair 10.

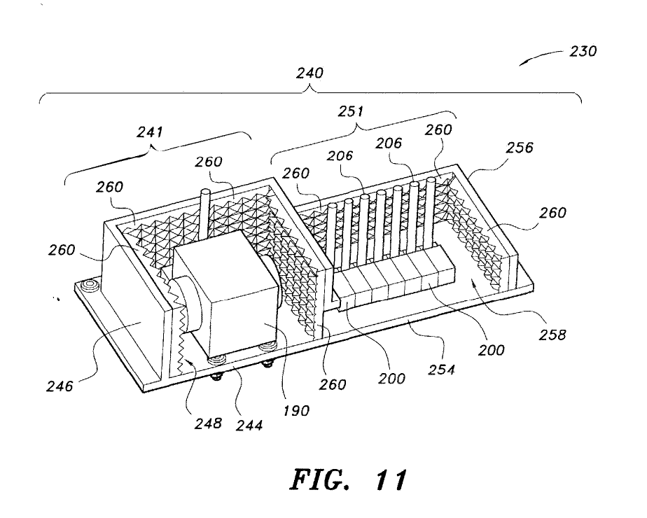

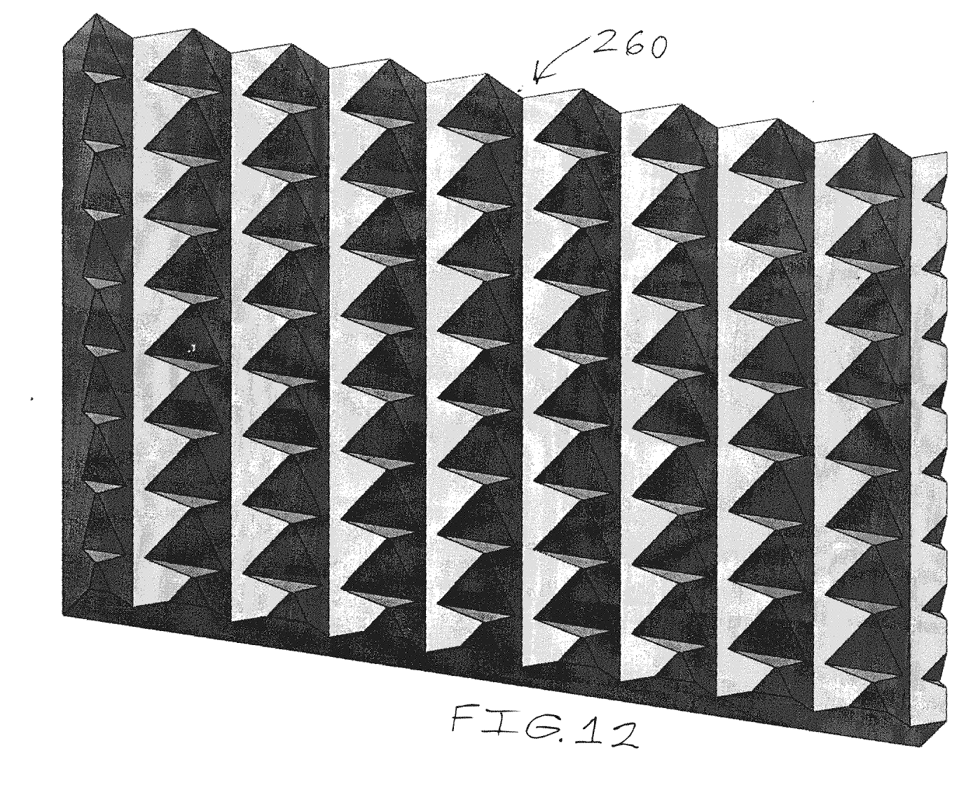

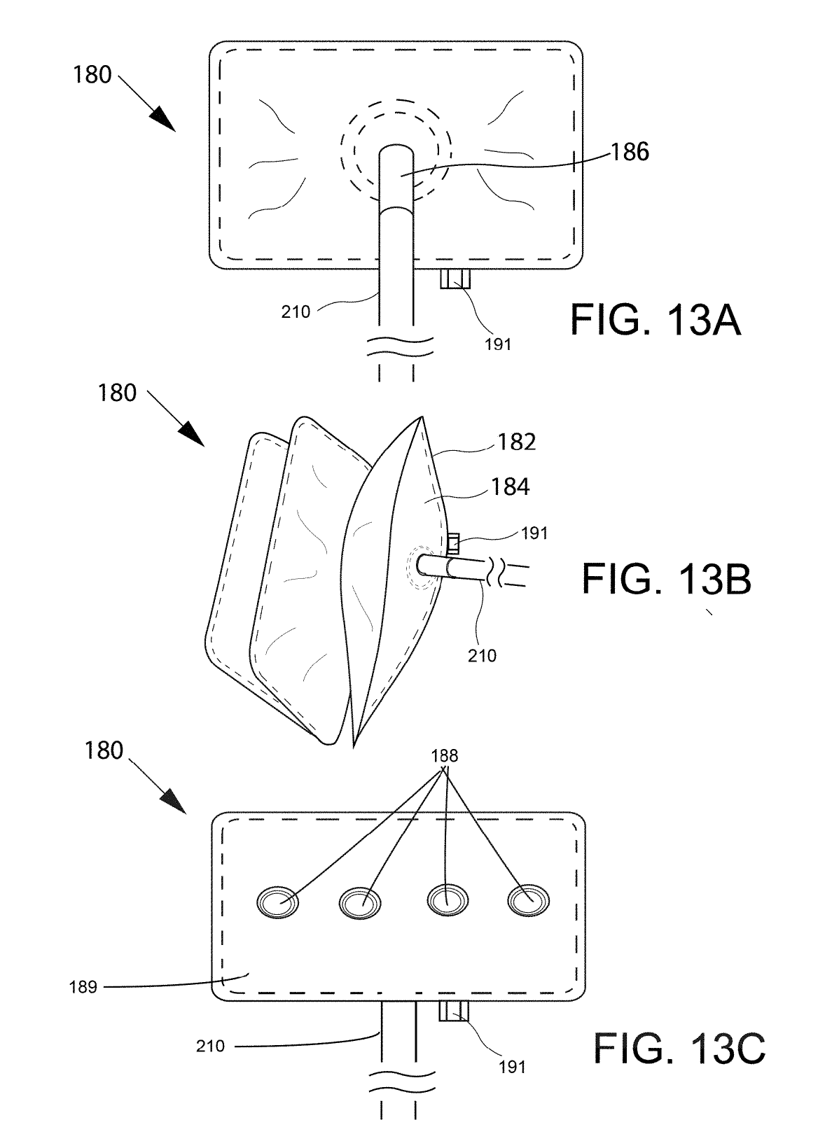

Each of the plurality of air massage elements 180 is adapted for having air transported or pumped into it by the air compressor or pump 190 and for having air withdrawn from it. The plurality of air massage elements 180 may be positioned at predetermined massage locations on, about, or in the vicinity of the massage chair frame 110 and/or may be moved or transported to desired massage locations by the user. The plurality of air massage elements 180 may be a plurality of air massage cells (such as, but not limited to, air cell 180 shown in FIGS. 13A, 13B, and 13C), a plurality of air massage bags (such as, but not limited to, air bags), any air massage element(s) known to one of ordinary skill in the art, and any combination thereof. The air cell 180 includes an inflatable or expandable air cell housing 182, an air cell chamber 184 defined by the air cell housing 182, and an air cell inlet and outlet 186. The air that is contained in and/or pumped into and out of the plurality of air massage elements 180 may be air, a liquid, a gel, any air(s) known to one of ordinary skill in the art, and any combination thereof.

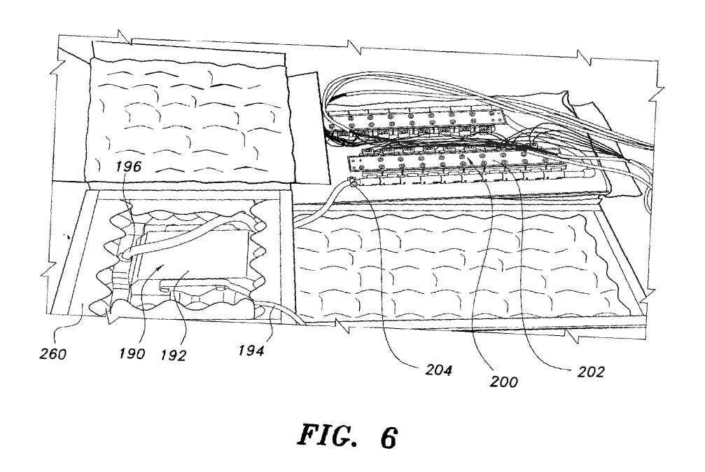

The air compressor or pump 190 pumps air into the plurality of air massage elements 180 such that massaging effects can be provided to the user at desired massage locations or pressure points. The air compressor or pump 190 comprises an air pump body 192, an air pump power source 194, and an air pump outlet 196. The air compressor or pump 190 (such as the non-limiting example shown in FIGS. 6, 10 and 11) may be any air compressor or pump known to one of ordinary skill in the art that is able to pump air, a liquid, a gel, any air(s) known to one of ordinary skill in the art, and any combination thereof into the plurality of air massage elements 180.

The plurality of air valve devices 200 regulate air flow into and out of the plurality of air massage elements 180. Each of the air valve device 200 comprises an air valve body 202, an air valve inlet 204, and an air valve outlet 206. Each of the plurality of air valve devices 200 (such as the non-limiting example shown in FIGS. 6, 10 and 11) may be any air valve device known to one of ordinary skill in the art that is able to regulate air flow into and out of the corresponding air massage element(s) 180.

The plurality of air transport devices 210 transport air flow into and out of the plurality of air massage elements 180. Each of the plurality of air transport devices 210 (such as the non-limiting example shown in FIGS. 13A, 13B, and 13C) may be any air transport device known to one of ordinary skill in the art that is able to transport air flow into and out of the corresponding air massage element(s) 180.

The power source 194 provides power to the air compressor or pump 190, and may also be used to provide power to other components of the massage chair 100. The power source 194 may be a battery, a connector or cord for plugging into a power outlet (such as, but not limited to, a detachable DC power supply cord), a plug for receiving power or electricity, any power source known to one of ordinary skill in the art, and any combination thereof.

As best shown in FIGS. 5-12, the noise-reducing (or noise-absorbing, noise-containing, or noise-cancelling) enclosure device 230 includes an enclosure housing 240 and noise-reducing (or noise-absorbing, noise-containing, or noise-cancelling) material 260 positioned inside the enclosure housing 240. The enclosure housing 240 encloses the air compressor or pump 190 and the plurality of air valve devices 200 during operation. The noise-reducing enclosure device 230 is preferably positioned in proximity of the massage chair frame 110. As a non-limiting example shown in FIGS. 1 and 5, the noise-reducing, enclosure device 230 is positioned below the seat or bottom body area portion 126R,126L of the massage chair frame 110.

As a non-limiting example and as best shown in FIGS. 6-11, the enclosure housing 240 has a first section 241 that includes a top 242, a bottom 244, a plurality of sides 246, an inner surface 248, and an outer surface 249, and a second section 251 that includes a top 252, a bottom 254, a plurality of sides 256, an inner surface 258, and an outer surface 259. Preferably, the inner surfaces 248, 258 and noise-reducing (or noise-absorbing, noise-containing, or noise-cancelling) material 260 help to form noise-reducing (or noise-absorbing, noise-containing, or noise-cancelling) walls for the enclosure housing 240. The first section 241 of the enclosure housing 240 encloses (partially, substantially, or fully encloses) the air compressor or pump 190 while the second section 251 of the enclosure housing 240 encloses (partially, substantially, or fully encloses) the plurality of air valve devices 200 such that noise generated from or made by the air compressor or pump 190 and the plurality of air valve devices 200 during operation is reduced, contained, or eliminated. The enclosure housing 240 also has a plurality of foot elements 243 positioned at predetermined locations on the periphery of the enclosure housing 240, and a plurality of screw and nut elements 245 positioned at predetermined locations.

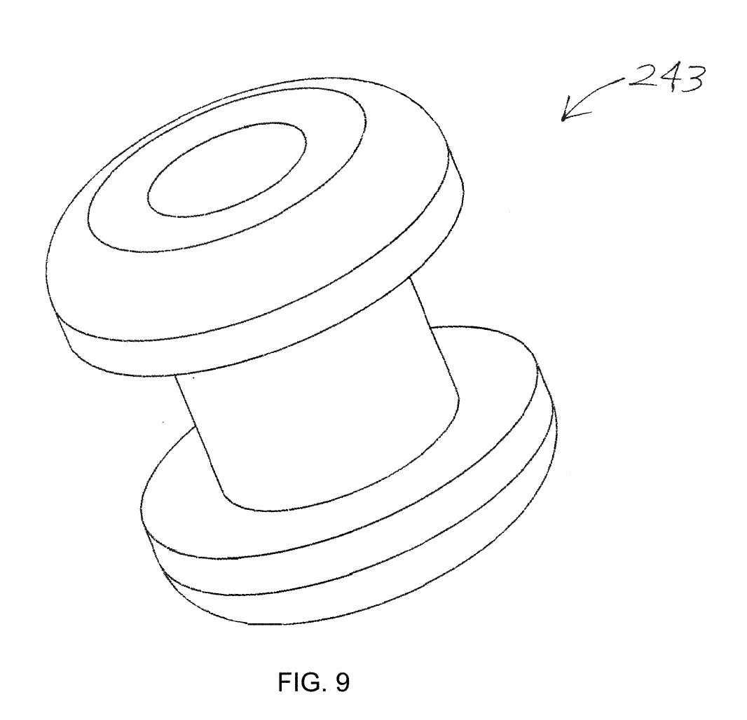

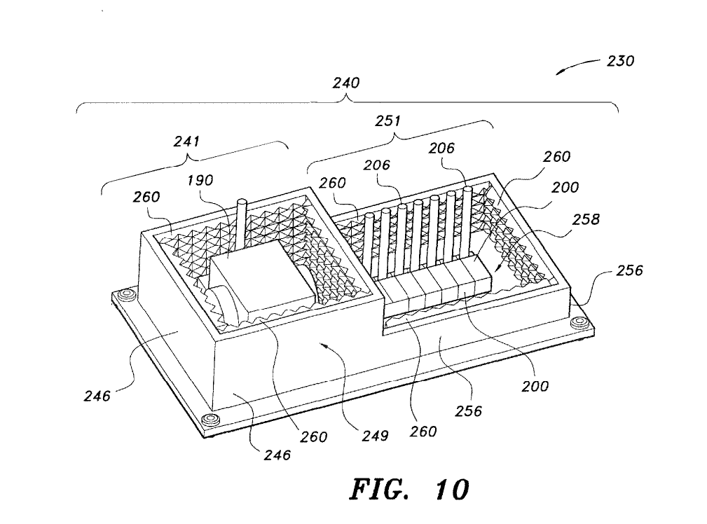

Preferably, the noise-reducing (or noise-absorbing, noise-containing, or noise-cancelling) material 260 is positioned inside the enclosure housing 240 in such a way that it surrounds the air compressor or pump 190 and the plurality of air valve devices 200 such that noise generated from or made by the air compressor or pump 190 and the plurality of air valve devices 200 during operation is reduced, contained or eliminated. Preferably, as shown in FIGS. 10 and 11, all of the inner surfaces 248, 258 of the enclosure housing 240 are covered by the noise-reducing material 260. Preferably, all of the electro-mechanical components positioned inside the enclosure housing 240 are fully surrounded by the noise-reducing material 260. The noise-reducing material 260 may be foam, noise-reducing foam, noise-absorbing foam, noise-containing foam, noise-cancelling foam, any noise-reducing material known to one of ordinary skill in the art, any noise-absorbing material known to one of ordinary skill in the art, any noise-containing material known to one of ordinary skill in the art, any noise-cancelling material known to one of ordinary skill in the art, and any combination thereof.

When in use or in operation, the user (not shown) may activate the massage system 170 of the massage chair 100 by or via pushing, touching, using voice command for use on or with, using a mechanical or remote control for use on or with, or any other activation method known to one of ordinary skill in the art, an activation, start, control or command button, touch area, box or panel, or any other activation method or element known to one of ordinary skill in the art. Preferably, the user is able to control the massage producing-effects of the plurality of air massage elements 180 such that the plurality of air massage elements 180 provide massage producing-effects to a desired body part area(s), such as the thighs, bottom, lower back, upper back, head and neck, and/or lower leg of the user so that desired body part area(s) of the user can receive massage effects or benefits from the plurality of air massage elements 180 when desired.

Additionally, FIG. 13A, FIG. 13B, and FIG. 13C further illustrate that the plurality of air massage elements 180 may include heating functionality. In this regard, as illustrated in FIG. 13C, the plurality of air massage elements 180 may include heated acupunctures 188. The heated acupunctures 188 may be located on an air cell front side 189. The heated acupunctures 188 may be located in other locations on or within the massage chair 10 as well. The heated acupunctures 188 may include a heating device to raise a temperature of the heated acupunctures 188. The heated acupunctures 188 may further include a power connector 191 to provide power to the heated acupunctures 188 for operating the heating device.

The heated acupunctures 188 may further include a circuit, a controller, or the like to control or vary a temperature of the heated acupunctures 188 in response to user input or a temperature sensor. In one aspect, the user input may be input to an input device. The input device may include switches, buttons, a touch sensitive screen, and the like. The user input may also include voice activation or voice control utilizing voice recognition software.

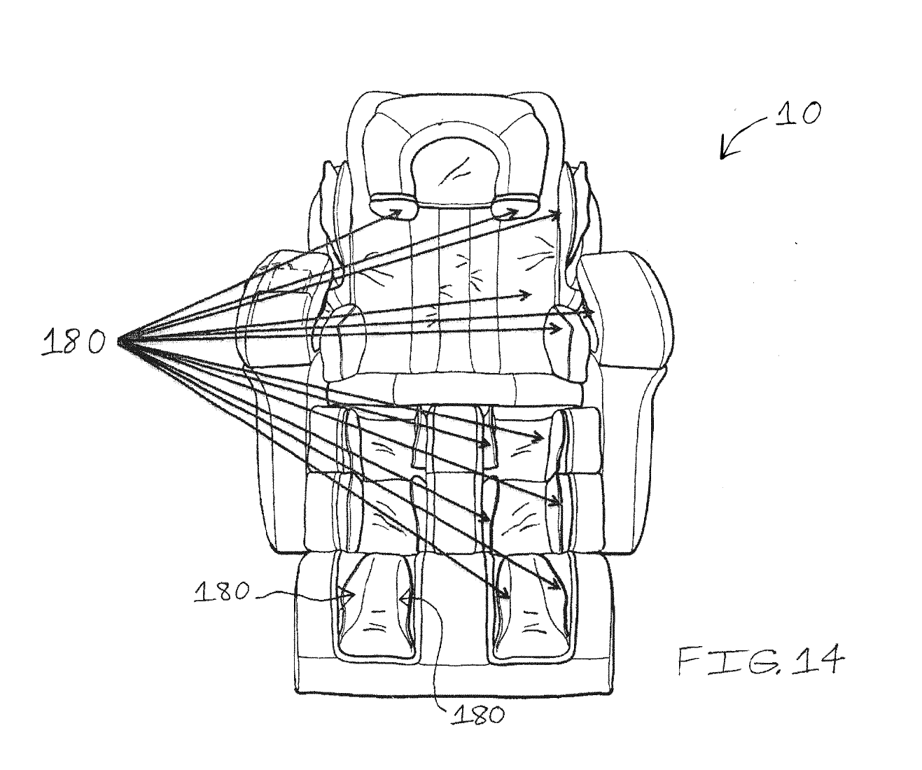

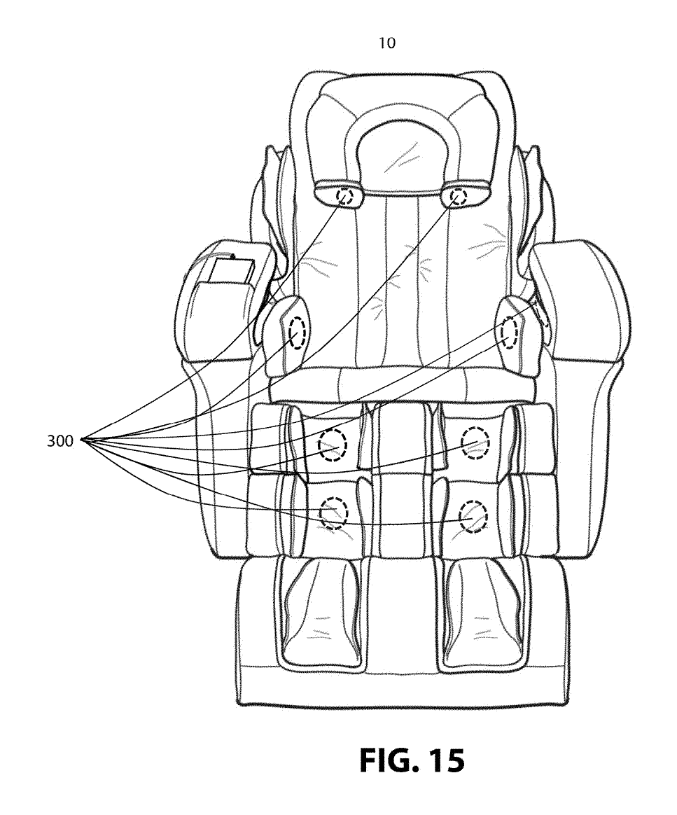

FIG. 15 is an elevated, front view of a massage chair, showing multiple locations where hammer punching devices may be positioned.

In particular, FIG. 15 illustrates the massage chair 10 having a plurality of hammer punching devices 300 located at various locations in the massage chair 10. In one aspect, one or more of the plurality of hammer punching devices 300 may be located adjacent headrest. In one aspect, one or more of the plurality of hammer punching devices 300 may be located adjacent a thigh area. In one aspect, one or more of the plurality of hammer punching devices 300 may be located adjacent an armrest area. In one aspect, one or more of the plurality of hammer punching devices 300 may be located adjacent a lower leg area. Other locations for the plurality of hammer punching devices 300 are contemplated as well.

In particular, the hammer punching devices 300 may provide a punching massage effect to a user positioned in the massage chair 10. In operation, the hammer punching devices 300 may provide a rapid movement and associated application of repeated pressure and/or impact to a user at various locations of the user's body. In this regard, the hammer punching devices 300 may provide a massaging affect to the user as they are sitting in the massage chair 10.

FIG. 16 illustrates a cross-sectional view of a punching device according to the disclosure; and FIG. 17 illustrates a perspective view of a punching device according to the disclosure.

In particular, FIG. 16 and FIG. 17 illustrate details of one of the hammer punching devices 300. The hammer punching device 300 may include a punching cylinder 302 configured to move with respect to a housing 306 as indicated by the arrows in FIG. 16. One or both ends of the punching cylinder 302 may include a soft layer 304. The soft layer 304 may include leather, plastic, rubber, a synthetic material, or the like. In one aspect, the soft layer 304 may soften the impact of the punching cylinder 302 on a user.

The hammer punching device 300 may further include a coil 308 to move the punching cylinder 302 as indicated by the arrows when provided with power from a power supply 310. The power supply 310 may be an alternating current (AC) power supply or a direct current (DC) power supply. The hammer punching device 300 may further include a circuit, controller, microprocessor, or the like to control the hammer punching device 300. In particular, the hammer punching device 300 may be controlled such that the punching cylinder 302 has a particular range of motion, a frequency of movement, and a set amount of force. In one aspect, the hammer punching device 300 may be controlled by user input. In one aspect, the user input may be input to an input device. The input device may include switches, buttons, a touch sensitive screen, and the like. In one aspect, user input may also include voice activation or voice control utilizing voice recognition software.

The housing 306 may house the coil 308 and it may partially house the punching cylinder 302. The housing 306 may further include a noise reducing material 206 consistent with the remaining disclosure.

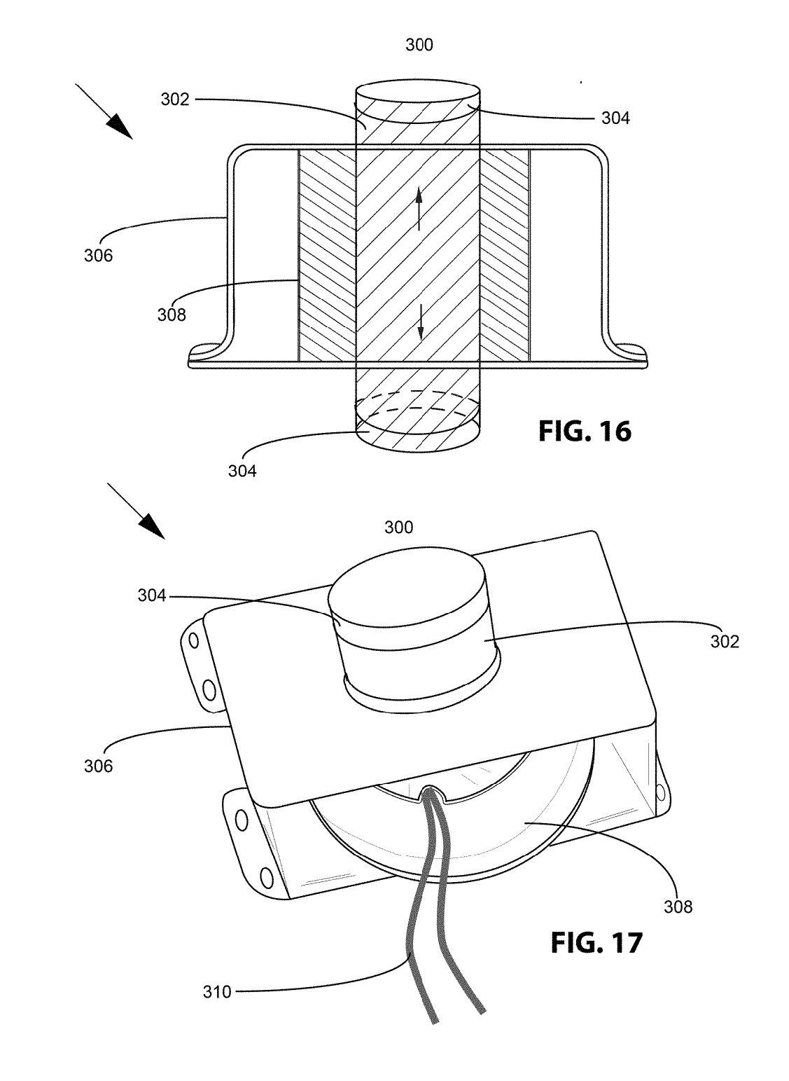

FIG. 18 is an exploded view of the chair with armrest removed according to the disclosure; and FIG. 19 illustrates an armrest sliding feature according to another aspect of the disclosure.

In particular, FIG. 18 and FIG. 19 illustrate a slide rack that may allow the armrest 316 to slide forward or backward wherein the sliding rack may be mounted to a side of a base stand of the massage chair 10. Additionally, the slide rack may include at least a locking mechanism to lock the armrest 316 at one position (not shown).

In particular, an armrest 316 may include a second section 251, a slide rack 312, and a corresponding slide rack 318. In one aspect, the slide rack 312 and the corresponding slide rack 318 may cooperate to mechanically fasten the armrest 316 to the massage chair 10. Additionally, the slide rack 312 and the corresponding slide rack 318 may cooperate to mechanically allow the armrest 316 to move toward the front of the massage chair 10 as well as move toward the rear of the massage chair 10. In this regard, the armrest 316 may be positioned at any desired location consistent with the desires of the user. Moreover, the armrest 316 may be removed for shipping as well as delivery.

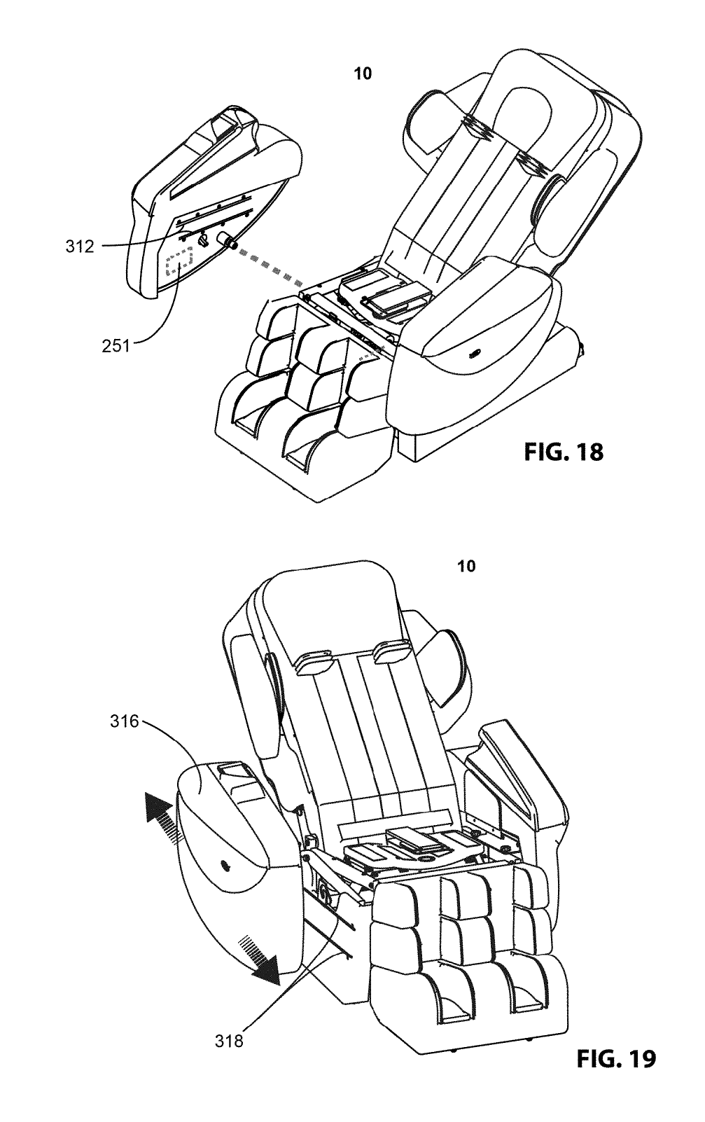

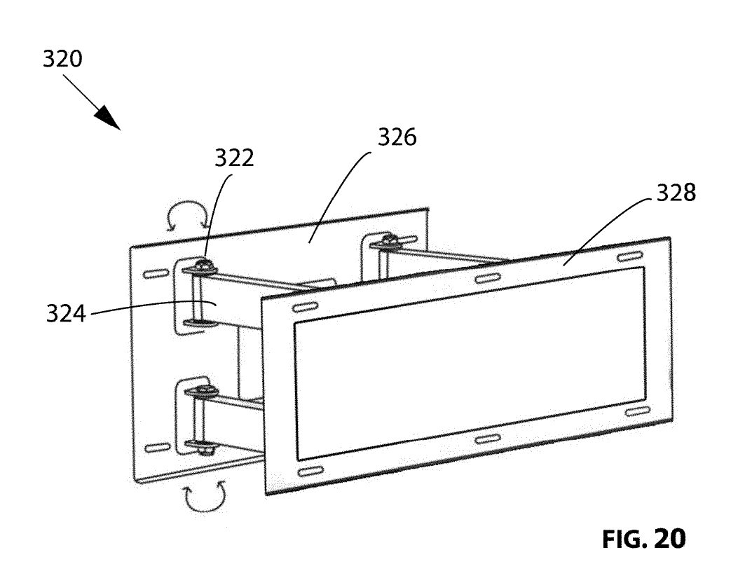

FIG. 20 is a perspective view of a sliding wing, another mounting option for armrest sliding feature according to another aspect of the disclosure.

In particular, FIG. 20 illustrates a support structure 320 for supporting an armrest 316. The support structure 320 may have a plurality of arms 324 that are pivotally connected to a base structure 326. In particular, the arms 324 may pivot as indicated by the arrows on a pivot joint 322 connected to the base structure 326. This allows an armrest connection portion 328 of the support structure 320 to be moved to any desired position. In one aspect, the support structure 320 may support the armrest 316 on the armrest connection portion 328. In particular, the base structure 326 may be connected to a side of the massage chair 10 and the armrest 316 may be connected to the armrest connection portion 328. With this configuration, the armrest 316 being connected to the armrest connection portion 328 may pivot and translate in a forward and backwards motion to be placed in an infinite number of positions as desired by the user of the massage chair 10.

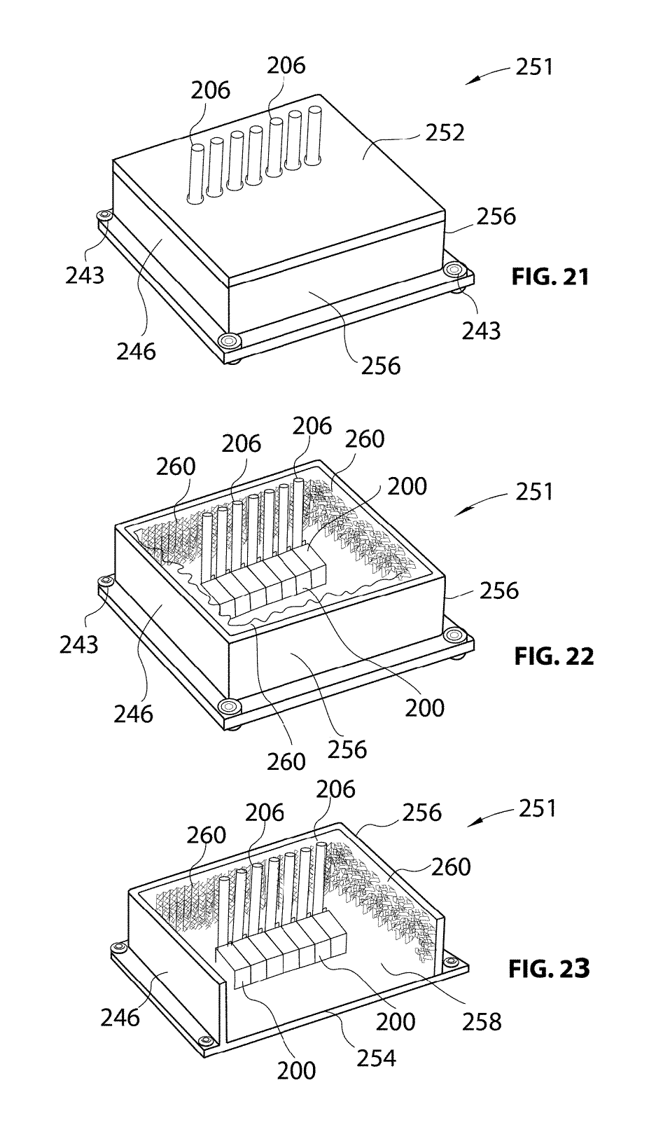

FIG. 21 illustrates a perspective view of an enclosure section for air valves according to the disclosure; FIG. 22 illustrates a perspective view of the enclosure section for air valves according to FIG. 21 with a top cover removed; and FIG. 23 illustrates a perspective view of the enclosure section for air valves according to FIG. 21 with a top cover in front cover removed.

In particular, FIG. 21, FIG. 22, and FIG. 23, illustrate the second section 251 of an enclosure housing that encloses (partially, substantially, or fully encloses) the plurality of air valve devices 200 such that noise generated from or made by the plurality of air valve devices 200 during operation is reduced, contained, or eliminated. The second section 251 may also have a plurality of foot elements 243 positioned at predetermined locations on the periphery of the second section 251. Additionally, the second section 251 may be configured to allow the air valve outlets 206 to extend from the second section 251 for connection to the plurality of air massage elements 180.

The second section 251 may include a top 252, a plurality of sides 246, a plurality of sides 256, an inner surface 258, and an outer surface. Preferably, the inner surfaces 258 and noise-reducing (or noise-absorbing, noise-containing, or noise-cancelling) material 260 form noise-reducing (or noise-absorbing, noise-containing, or noise-cancelling) walls for the second section 251. The second section 251 encloses (partially, substantially, or fully encloses) the plurality of air valve devices 200.

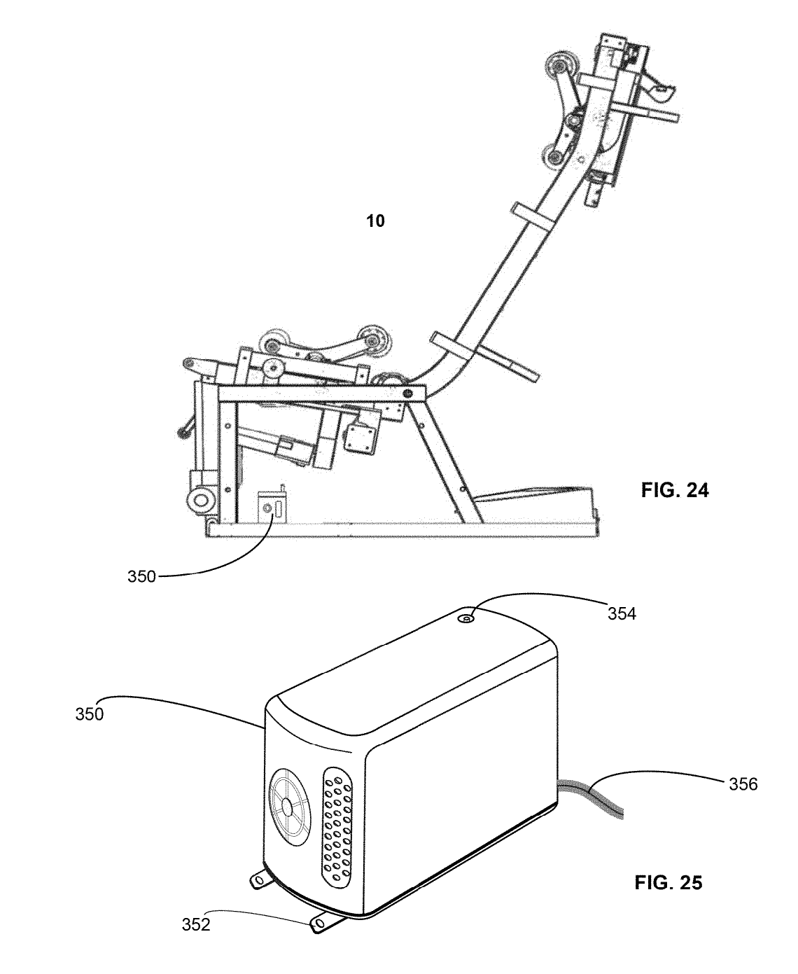

FIG. 24 illustrates a side view of the massage chair frame with oxygen generator according to the disclosure; and FIG. 25 illustrates an oxygen generator according to the disclosure.

In particular, FIG. 24 and FIG. 25 illustrate an Oxygen Concentrator Generator to provide Oxygen Therapy to the user. Generation of oxygen for a user may have a number of pleasant or beneficial effects for a user. Moreover, the user may medically need a higher percentage of oxygen in their environment for medical reasons.

FIG. 24 illustrates an exemplary positioning and arrangement of an oxygen generator 350 within the massage chair 10. In one aspect, the oxygen generator 350 may be configured as an oxygen concentrator that may concentrate oxygen from a gas supply (typically ambient air) by selectively removing nitrogen to supply an oxygen-enriched gas stream. In one aspect, the oxygen generator 350 may operate utilizing pressure swing adsorption (PSA) technology. FIG. 25 illustrates further details of the oxygen generator 350. The oxygen generator 350 may include an oxygen outlet 354, a power supply 356, mounting structures 352, and the like.

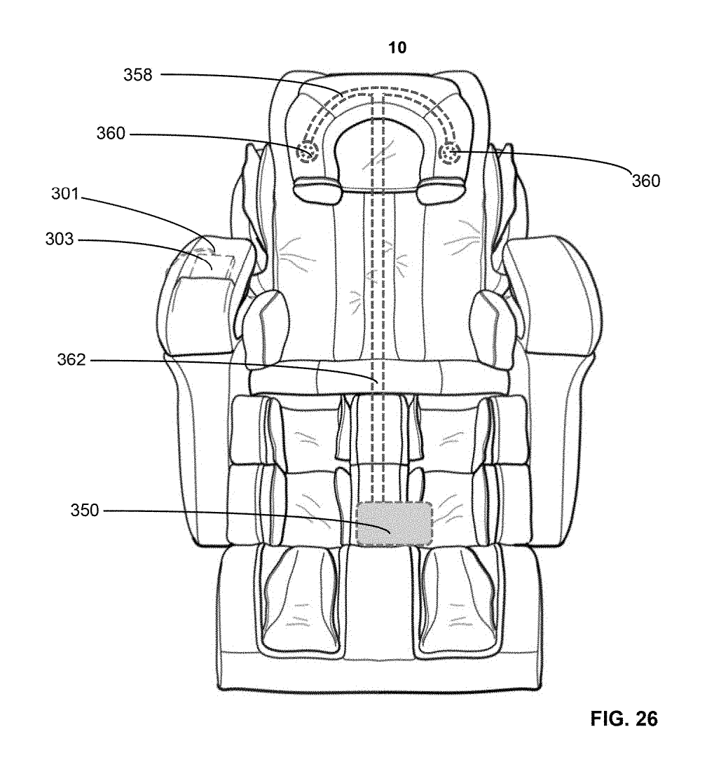

FIG. 26 illustrates a massage chair having an oxygen distribution system according to the disclosure.

In particular, FIG. 26 illustrates an oxygen distribution system that may include the oxygen generator 350 located within the massage chair 10 as illustrated in FIG. 25. Moreover, the oxygen distribution system may include an oxygen tube 362 that may be connected to the oxygen generator 350 that may extend toward the top of the massage chair 10. Additionally, the oxygen distribution system may include an oxygen tube 358 that may connect to the oxygen tube 362. In one aspect, there may be a manifold connecting the oxygen tube 358 to the oxygen tube 362. In one aspect, one or more oxygen vents 360 may be positioned at the end of the oxygen tube 358. The oxygen vents 360 may be located near a headrest portion of the massage chair 10. In operation, the oxygen generator 350 creates an oxygen rich supply of air that is output from the oxygen outlet 354. The oxygen outlet 354 may be connected to the oxygen tube 362 delivering the oxygen rich supply of air to the oxygen tube 358 and subsequently to the oxygen vents 360 for delivery to the environment of the user near the headrest of the massage chair 10.

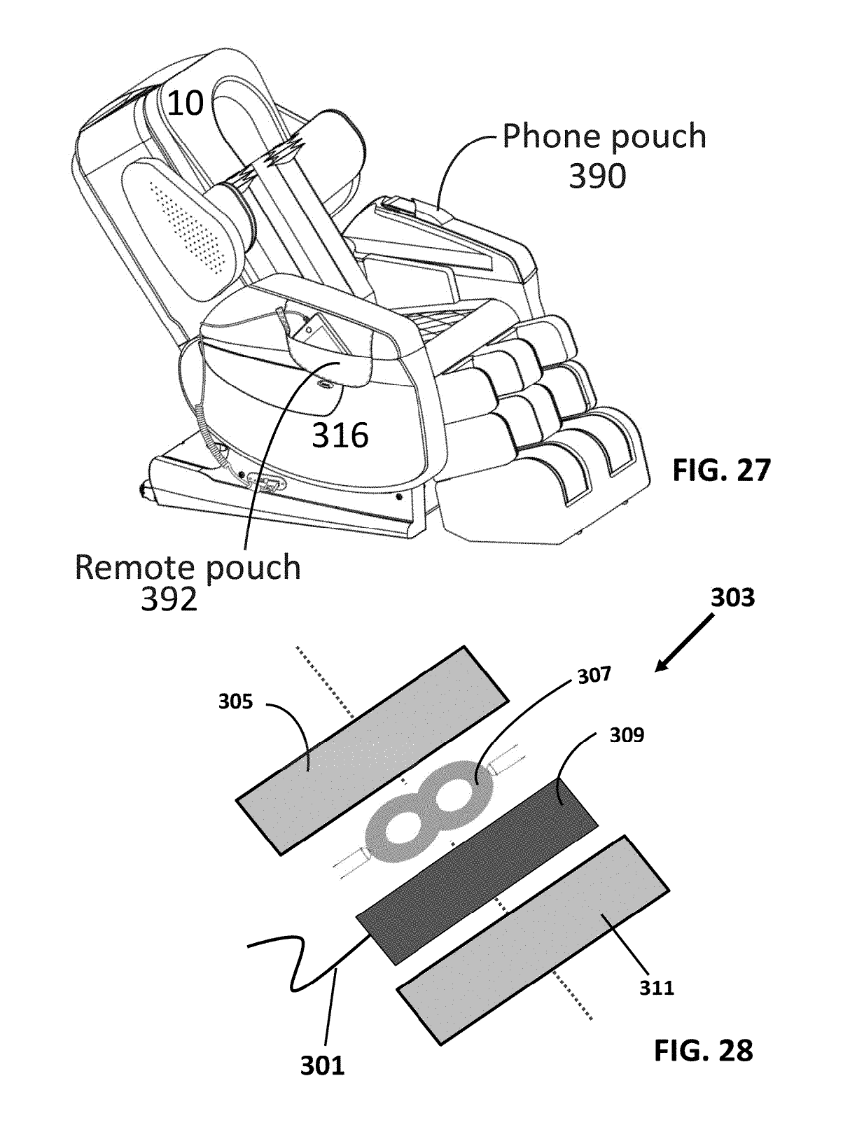

FIG. 27 illustrates a massage chair having a wireless device pouch and/or a remote control pouch according to the disclosure.

In particular, FIG. 27 illustrates that the massage chair 10 may include a wireless device pouch 390 and/or a remote control pouch 392. In one aspect, the remote control pouch 392 may be sized to receive a remote control for an audiovisual device such as a television, media player, DVR, cable box, stereo, and the like. The remote control pouch 392 may be formed of fabric that is the same or consistent with the massage chair 10 in order to have a pleasing and integrated appearance. In one aspect, the remote control pouch 392 may be formed of multiple connected fabric portions creating a pocket to insert the remote control into the remote control pouch 392. Other constructions are contemplated as well. In one aspect, the remote control pouch 392 may be connected to the armrest 316 in order to be easily accessed by the user of the massage chair 10.

Additionally or alternatively, the massage chair 10 may include a wireless device pouch 390 that may be sized to receive a wireless device such as a phone, smartphone, tablet computer, and the like. The wireless device pouch 390 may be formed of fabric that is the same or consistent with the massage chair 10 in order to have a pleasing and integrated appearance. In one aspect, the wireless device pouch 390 may be formed of multiple connected fabric portions creating a pocket to insert the wireless device into the wireless device pouch 390. Other constructions are contemplated as well. In one aspect, the wireless device pouch 390 may be connected to the armrest 316 in order to be easily accessed by the user of the massage chair 10. In a further aspect, the wireless device pouch 390 may include a wireless charger 303 as described in relation to FIG. 28.

FIG. 28 illustrates a wireless charger configured to be implemented in the massage chair according to the disclosure.

In particular, the massage chair 10 may include a fast wireless charger 303 configured for charging a wireless device such as a phone, smartphone, tablet computer, and the like. In one aspect, the fast wireless charger 303 may be integrated with the wireless device pouch 390. The fast wireless charger 303 may be configured as a charging pad for the wireless device. The fast wireless charger 303 may include a power connector 301 for providing power to the fast wireless charger 303.

In one aspect, the fast wireless charger 303 may be integrated into the massage chair 10. In one aspect, the fast wireless charger 303 may be located adjacent, under, or integrated into the wireless device pouch 390. In one aspect, the fast wireless charger 303 may provide wireless power to charge a phone or similar portable devices. The fast wireless charger 303 may include a top cover 305, a coil 307, an electronic charging control printed circuit board (PCB) 309, a cable 301 to receive power, a bottom cover 311. Power for the fast wireless charger 303 may be supplied by the massage chair 10. In this regard, fast wireless charger 303 may transfer energy from the fast wireless charger 303 to a receiver in the back of the wireless device via electromagnetic induction. The fast wireless charger 303 may use the coil 307 implemented as an induction coil to create an alternating electromagnetic field, which a receiver coil in the wireless device converts back into electricity to be fed into the battery of the wireless device.

The fast wireless charger 303 may be configured to Intelligently Identify Charging Devices and the fast wireless charger 303 may be configured to vary the power is applied to the wireless device from 5 W to 10 W mode using QC2.0/QC3.0 adapter. In one aspect, the fast wireless charger 303 may be configured to be very light and thin, and the fast wireless charger 303 may be configured to provide good heat dissipation. Additionally, the massage chair 10 may also be configured with the fast wireless charger 303 to provide good heat dissipation

In one aspect, the fast wireless charger 303 may be case friendly. In this regard, the fast wireless charger 303 may be configured charge straight through even extra-tough cases. Of course, such implementations may affect the charging speed a little and metal attachments or credit cards may interfere with charging.

In further aspects, the fast wireless charger 303 may be configured with High-efficiency Charging & Multiple Protection. In one aspect, the fast wireless charger 303 may be configured with a charging speed that is up to 20% faster than prior art wireless chargers. In further aspects, the fast wireless charger 303 may be configured with temperature protection, input voltage protection, input current protection, short circuit protection, and other multiple safety protection, to ensure the safety of the wireless device and the massage chair 10 during the entire charging process.

In further aspects, the fast wireless charger 303 may include a soft breathing light. In this regard, the fast wireless charger 303 may implement the soft breathing light after entering the charging mode and the soft breathing light will slowly pulse indicating charging of the wireless device by the fast wireless charger 303.

The disclosure has disclosed a massage chair having a massage chair frame, a massage system that includes a plurality of air massage elements, and a noise-reducing (or noise-absorbing, noise-containing or noise-cancelling) enclosure device. Additionally, the disclosure has disclosed additional features for improving user experience including hammering devices, heating acupuncture devices, oxygen generation, voice recognition control of the massage chair, a remote control pouch, and a wireless device pouch having wireless charging functionality. All of these features provide an improved experience for the user using the massage chair 10.

The controller as described in the disclosure may include a processor, a microprocessor, a random-access memory, a read-only memory, input devices, output devices, and the like. The microprocessor may implement software for operating the various features of the massage chair 10. In one aspect a microprocessor may implement voice recognition software. The input devices may include switches, buttons, a touch sensitive screen, microphones, and the like for operating the various features of the massage chair 10.

Voice recognition software may be utilized in various aspects of the systems and methods. Users may be able to vocalize, rather than utilizing other input processes. For example, the voice recognition software may be configured for generating text from voice input from a microphone or other voice input. A speech signal processor may convert speech signals into digital data that can be processed by the processor. The processor may perform several distinct functions, including serving as the speech event analyzer, the dictation event subsystem, the text event subsystem, and the executor of the application program. The speech signal processor may generate speech event data and transmit this data to the processor to be processed first by the speech event analyzer. The speech event analyzer may generate a list or set of possible candidates among the system recordings that represent or match the voice input processed by the speech signal processor. The speech event analyzer may transmit the candidate sets to a dictation event subsystem. The dictation event subsystem may analyze the candidate sets and choose the best match candidate with the highest degree of similarity. This candidate is then considered the correct translation, and the dictation event subsystem forwards the translation to the text event subsystem which in turn inputs the translated text into the device.

It is to be understood that the disclosure is not limited to the embodiments described above or as shown in the attached figures, but encompasses any and all embodiments within the spirit of the invention.

What is claimed is:

1. A massage chair comprising:
a massage chair frame comprising a first end, a second end, a seat or bottom body area portion, and a back body area portion extending upward from said bottom body area portion toward said second end;
a massage system in operational communication with said massage chair frame such that said massage system provides massaging effects to a user positioned in said massage chair,
wherein said massage system comprises at least one air compressor or pump, at least one air valve device for regulating air flow into and out of at least one air cell, at least one air transport device for transporting air flow into and out of said at least one air cell, and a power source,
wherein each of said at least one air cell is adapted for having air transported or pumped into it by said air compressor or pump and for having air withdrawn from it; and
a noise-reducing chamber comprising an enclosure housing,
wherein said enclosure housing encloses said air compressor or at least one air valve device during operation so that noise generated from or made by said air compressor or air valve device is reduced or eliminated.

2. The massage chair according to claim 1, wherein said noise reducing enclosure housing further comprises a layer of noise-reducing material.

3. The massage chair according to claim 2, wherein said noise-reducing material is selected from the group consisting of foam, noise-reducing foam, and any combination thereof.

4. The massage chair according to claim 1, wherein said massage chair frame further comprises a head and neck body area portion extending upward from said back body area portion and located about said second end, and a lower leg body area portion located downward from a thigh body area portion and located about said first end.

5. The massage chair according to claim 1, wherein said massage chair further comprises a wireless charger.

6. The massage chair according to claim 1, further comprising:
a controller;
a microphone; and
the controller having a processor implementing a voice recognition software configured to receive voice commands from the microphone, and the controller configured to control an operation of the massage chair based on the voice commands.

7. The massage chair according to claim 1, wherein said at least one air cell comprises at least one acupuncture point.

8. The massage chair according to claim 7, wherein said at least one acupuncture point further comprises a heat element.

9. The massage chair according to claim 1, wherein said massage chair frame has a generally “L-Shaped” configuration.

10. A massage chair comprising:
a massage chair frame comprising footrest portion, a seat or bottom body area portion, and a back body portion, and an armrest portion;
a massage system in operational communication with said massage chair frame such that said massage system provides massaging effects to a user positioned in said massage chair,
wherein said massage system comprises at least one air compressor or pump, at least one air valve device for regulating air flow into and out of at least one air cell, at least one air transport device for transporting air flow into and out of said at least one air cell, and a power source,
wherein each of said at least one air cell is adapted for having air transported or pumped into it by said air compressor or pump and for having air withdrawn from it; and
an oxygen generator or concentrator to provide oxygen therapy to the user.

11. The massage chair according to claim 10, wherein said oxygen generator or concentrator further comprises at least one vent.

12. The massage chair according to claim 11, wherein said at least one vent comprises a built-in pillow.

13. The massage chair according to claim 10, wherein further comprises noise-reducing comprising enclosure housing is positioned inside at least one armrest.

14. The massage chair according to claim 13, wherein said enclosure housing encloses at least one air valve device.

15. A massage chair comprising:
a massage chair frame comprising footrest portion, a seat or bottom body area portion, and a back body portion, and an armrest portion;
a massage system in operational communication with said massage chair frame such that said massage system provides massaging effects to a user positioned in said massage chair,
wherein said massage system comprises at least one air compressor or pump, at least one air valve device for regulating air flow into and out of at least one air cell, at least one air transport device for transporting air flow into and out of said at least one air cell, and a power source,
wherein each of said at least one air cell is adapted for having air transported or pumped into it by said air compressor or pump and for having air withdrawn from it; and
at least one hammer punching device that provides punching massage effect to a user positioned in said massage chair.

16. The massage chair according to claim 15, wherein at least one hammer punching device is positioned on the footrest.

17. The massage chair according to claim 15, wherein at least one hammer punching device is positioned on the armrest.

18. The massage chair according to claim 15, wherein at least one hammer punching device is positioned on a pillow.

19. The massage chair according to claim 15, wherein at least one hammer punching device further comprises a metal cylinder.

20. The massage chair according to claim 19, wherein one end of metal cylinder further comprises a soft material layer to reduce an impact noise, wherein said soft material comprises at least one of the following: leather, rubber, or plastic.

21. The massage chair according to claim 20, wherein said massage chair further comprises a wireless charger.

22. A massage chair comprising:
a massage chair frame comprising a first end, a second end, a seat or bottom body area portion, and a back body area portion extending upward from said bottom body area portion toward said second end;
a massage system in operational communication with said massage chair frame such that said massage system provides massaging effects to a user positioned in said massage chair,
wherein said massage system comprises at least one air compressor or pump, at least one air valve device for regulating air flow into and out of at least one air cell, at least one air transport device for transporting air flow into and out of said at least one air cell, and a power source,
wherein each of said at least one air cell is adapted for having air transported or pumped into it by said air compressor or pump and for having air withdrawn from it,
at least one heat element located adjacent to a surface of an airbag that provides a heat therapy for the user; and
at least one sliding rack or sliding wing that allows the armrest to slide forward or backward wherein sliding rack or sliding wing is mounted to a side of a stand.

23. The massage chair according to claim 22, wherein said slide rack or slide wing is made from a hard material.

24. The massage chair according to claim 22, further comprising:
a controller;
a microphone; and
the controller having a processor implementing a voice recognition software configured to receive voice commands from the microphone, and the controller configured to control an operation of the massage chair based on the voice commands.

25. The massage chair according to claim 22 further comprises at least one hammer punching device.

26. The massage chair according to claim 25, wherein at least one hammer punching device further comprises a metal cylinder.

27. The massage chair according to claim 26, wherein one end of metal cylinder further comprises a rubber or plastic to reduce an impact noise.

28. The massage chair according to claim 22 further comprise a noise-reducing comprising an enclosure housing.

29. The massage chair according to claim 22, wherein said massage chair further comprises a wireless charger.

30. The massage chair according to claim 22, wherein further comprises an oxygen generator or concentrator.
